(19) United States
(12) Patent Application Publication
(10) Pub. No.: US 2009/0304388 A1
(43) Pub. Date: Dec. 10, 2009

(54) Optical Branching Apparatus and Passive Optical Network System

(76) Inventors: Kazuyori UMEMATSU, Yokohama (JP); Yusuke Yajima, Fujisawa (JP); Tsuyoshi Kano, Yokohama (JP); Toshiki Sugawara, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/477,952

(22) Filed: Jun. 4, 2009

(30) Foreign Application Priority Data
Jun. 5, 2008 (JP) 2008-148064

(51) Int. Cl. H04J 14/02

(52) U.S. Cl. 398/72

(57) ABSTRACT

In the case where, in a WDM-PON system, a high-output optical signal or a pseudo signal for illegal access by a hostile user, or an optical signal with a wavelength which is not assigned from an OLT is input to an ONU-side optical fiber, the quality of communications for other users is possibly affected and a receiver on the station side is possibly destroyed. By providing an optical blocking unit at a position near an ONU-side optical splitter of an optical branching unit, in the case where input of an extraordinary optical signal is detected, an optical route into which the extraordinary optical signal is input is blocked, so that the input of the extraordinary optical signal to an OLT and optical lines shared by plural users can be preliminarily blocked.

### CLAIM OF PRIORITY

The present application claims priority from Japanese patent application serial no. 2008-148064, filed on Jun. 5, 2008, the content of which is hereby incorporated by reference into this application.

### BACKGROUND OF THE INVENTION

The present invention relates to a passive optical network (PON) and an optical branching apparatus in which plural optical network units share optical transmission lines, and particularly to a WDM-PON system and an optical branching apparatus in which transmission and reception wavelengths of optical network units are different from each other.

### DESCRIPTION OF THE RELATED ART

A PON includes an Optical Line Termination (OLT) and plural Optical Network Units (ONUs). ONU is also referred to as Optical Network Termination (ONT). The ONU optically-multiplexes a signal from a connected terminal (PC or the like) with an optical fiber by using an optical signal through an optical fiber and an optical splitter to be transmitted to the OLT. After various signal processing, the OLT intermediates communications from a terminal of the ONU to that of a different ONU or a terminal of a network.

Optical multiplexing schemes include TDM (Time Division Multiplexing), WDM (Wavelength Division Multiplexing), CDM (Code Division Multiplexing), and the like. In G-PON specified in ITU-T-recommended G.984.3, different wavelengths are used in uplink and downlink, and uplink communications of signals from the ONUs to the OLT are performed by the time division multiplexing (TDM) in which signal communication times are assigned to the ONUs.

On the other hand, in the WDM-PON system, the OLT and plural ONUs are coupled to each other by uplink and downlink optical signals with different wavelengths. Each ONU receives and transmits a specific wavelength for communications. The WDM-PON performs communications while assigning individual wavelengths from the OLT to the respective ONUs, so that one ONU occupies and uses a communication band with a specific wavelength. As a result, the WDM-PON can provide communication services with a higher speed as compared to a TDM-PON.

In the WDM-PON system where plural users share one optical line, and each user performs communications with a station-side apparatus by using optical signals with different wavelengths, when a high-output light is input to an optical fiber connected to the ONU by a hostile user, a receiver of the OLT is easily destroyed.

Further, in the case where a hostile user illegally accesses by using a wavelength assigned to a different user, information of a proper user using the wavelength is leaked, and its wavelength band is blocked, resulting in a non-communicative state.

Japanese Patent Application Laid-Open No. H10-303817 discloses an invention in which an optical breaker is provided on the subscriber side of a star coupler in a general PON system, and an optical signal with an extraordinarily-high power is blocked. However, Japanese Patent Application Laid-Open No. H10-303817 does not describe blocking against illegal access. In addition, optical detecting systems are provided on the subscriber side of the star coupler in the technique of Japanese Patent Application Laid-Open No. H10-303817, so that the detection systems corresponding to the number of branches are needed.

The present invention provides optical branching apparatus and passive optical network system, which are to block input of an extraordinary optical signal to an OLT and an optical line shared by plural users even when the extraordinary optical signal is input to an optical fiber connected to a user-side apparatus by a hostile user in a WDM-PON system.

### SUMMARY OF THE INVENTION

The above-described problem can be solved by an optical branching apparatus which is coupled to a main fiber and plural branch fibers, and in which an optical splitter is provided to branch a downlink optical signal from the main fiber into the branch fibers and plural uplink optical signals from the branch fibers are wavelength-multiplexed, the apparatus including: a coupler which is arranged between the main fiber and the optical splitter and branches the uplink wavelength-multiplexed optical signal into two; an optical blocking unit which is arranged between the branch fibers and the optical splitter; a first wavelength separating unit which is coupled to a first output of the coupler; plural optical receiving units which are connected to plural outputs of the first wavelength separating unit; a controlling unit which is connected to the plural optical receiving units and controls the optical blocking unit; and an in-apparatus fiber which couples a second output of the coupler to the main fiber, wherein when an extraordinary optical signal is detected by any one of the optical receiving units, the controlling unit controls the optical blocking unit for the corresponding uplink optical signal wavelength to be in a blocking state and blocks communications between the main fiber and the corresponding branch fiber.

Further, the above-described problem can be solved by a passive optical network system, including: an optical line termination; an optical branching apparatus; plural optical network units: a main fiber which couples the optical line termination to the optical branching apparatus; and plural branch fibers which couple the optical branching apparatus to the optical network units, wherein the optical branching apparatus includes: an optical splitter which branches a downlink optical signal from the main fiber into the branch fibers and wavelength-multiplexes plural uplink optical signals from the branch fibers; a coupler which is arranged between the main fiber and the optical splitter and branches an uplink wavelength-multiplexed optical signal into two; an optical blocking unit which is arranged between the branch fibers and the optical splitter; a first wavelength separating unit which is coupled to a first output of the coupler; plural optical receiving units which are connected to plural outputs of the first wavelength separating unit; a controlling unit which is connected to the optical receiving units to control the optical blocking unit; and an in-apparatus fiber which couples a second output of the coupler to the main fiber, and when an extraordinary optical signal is-detected by any one of the optical receiving units, the controlling unit controls the optical blocking unit for the corresponding uplink optical signal wavelength to be in a blocking state, and blocks communications between the main fiber and the corresponding branch fiber.

According to the present invention, it is possible to provide an optical branching apparatus and a passive optical network system with high reliability.

### BRIEF DESCRIPTION OF THE DRAWINGS

Preferred embodiments of the present invention will now be described in conjunction with the accompanying drawings, in which;

FIG. 1 is a block diagram of a WDM-PON system;

FIG. 2 is a diagram for explaining wavelength allocation of the WDM-PON system;

FIG. 3 is a block diagram of an optical branching unit; and

FIG. 4 is a diagram for explaining an example of wavelength distribution of an extraordinary optical signal.

### DESCRIPTION OF THE PREFERRED EMBODIMENT

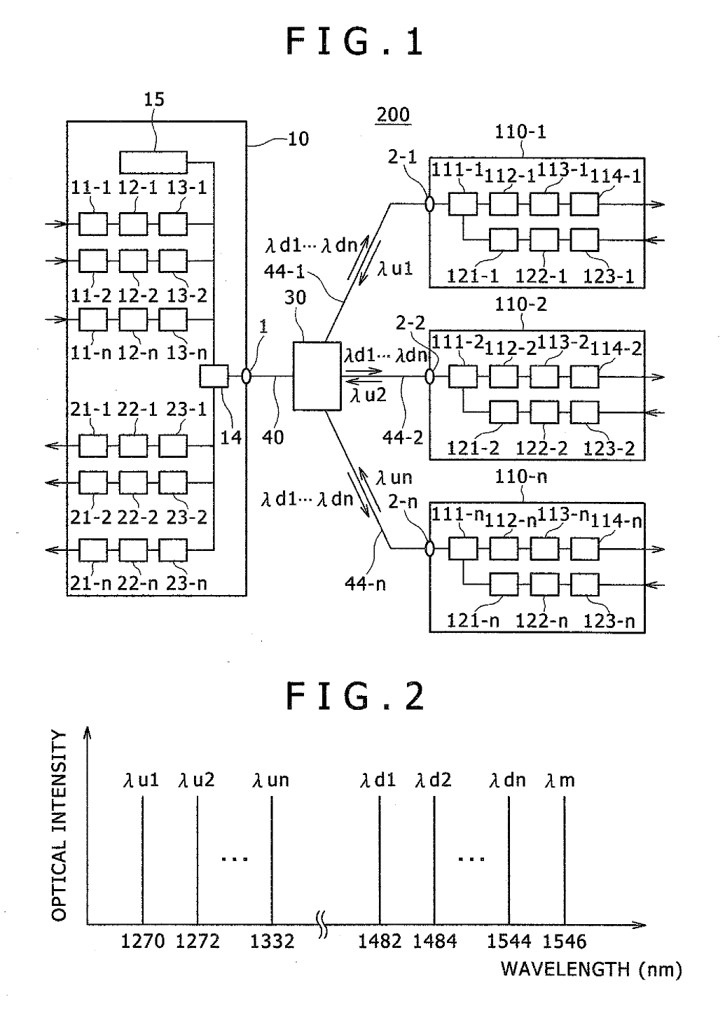

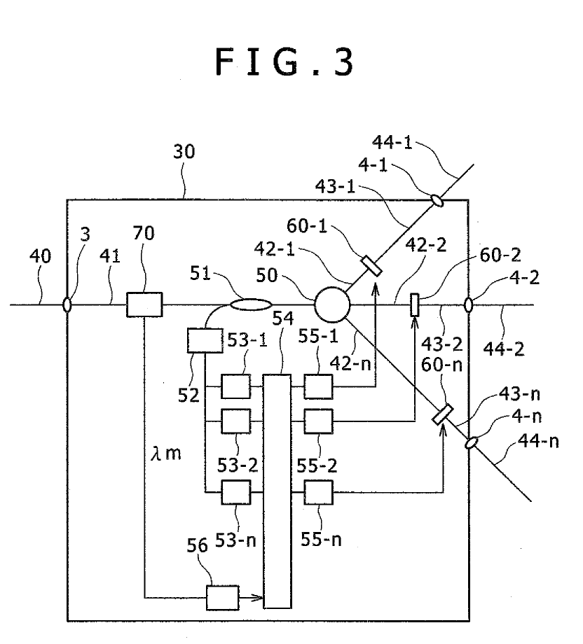

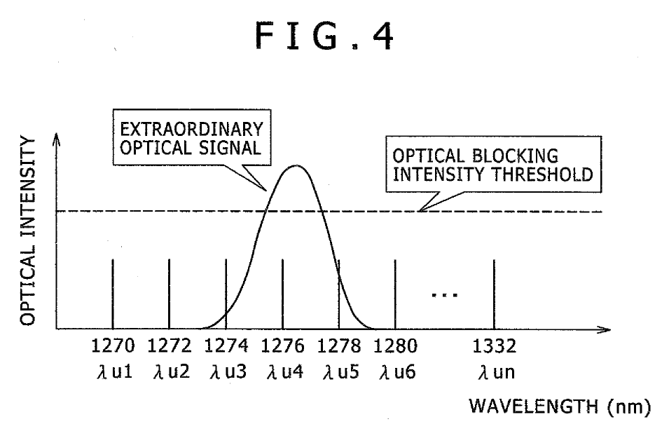

Hereinafter, an embodiment will be described with reference to FIG. 1 to FIG. 4. It should be noted that substantially the same constituent elements are given the same reference numerals, and the explanations thereof will not be repeated. Here, FIG. 1 is a block diagram of a WDM-PON system. FIG. 2 is a diagram for explaining allocation of wavelengths in the WDM-PON system. FIG. 3 is a block diagram of an optical branching unit. FIG. 4 is a diagram for explaining an example of wavelength distribution of an extraordinary optical signal.

In FIG. 1, a WDM-PON system 200 includes an OLT 10, ONUs 110, an optical branching unit 30, and optical fibers 40 and 44 for connecting them to each other. The OLT 10 and the ONUs 110 are connected to each other through an OLT-side optical fiber (main fiber) 40, the optical branching unit (optical branching apparatus) 30, and ONU-side optical fibers (branch fibers) 44. The OLT 10 and the OLT-side optical fiber 40 are connected to each other through an optical connector 1. The ONUs 110 and the ONU-side optical fibers 44 are connected to each other through an optical connector 2.

The OLT 10 includes transmission-side logic units 11, transmission-side analog front-end units 12, optical transmitting units 13, a WDM 14, a management signal transmitting unit 15, reception-side logic units 21, reception-side analog front-end units 22, and optical receiving units 23.

Each of the ONUs 110 includes a WDM 111, an optical receiving unit 112, a reception-side analog front-end unit 113, a reception-side logic unit 114, a transmission-side logic unit 123, a transmission-side analog front-end unit 122, and a wavelength variable optical transmitting unit 121.

Thirty-two ONUs 110 can be connected to the OLT 10. In FIG. 1, three ONUs are illustrated, and the wavelengths thereof used for communications with the OLT 10 are different from each other. A downlink optical signal wavelength λd1 and an uplink optical signal wavelength λu1 are assigned to the ONU 110-1. As similar to the above, λd2 and λu2 are assigned to the ONU-2, and λdn and λun are assigned to the ONU-n. Among signals transmitted in the directions from the OLT 10 to the ONUs 110, signals destined for the ONUs 110 are wavelength-multiplexed by the WDM 14 for transmission. The signal received by the ONU 110 selects and receives only a signal assigned to itself in the ONU 110. Further, in the direction from the ONUs 110 to the OLT 10, signals transmitted from the ONU 110-1, the ONU 110-2, and the ONU 110-n are wavelength-multiplexed by the optical branching unit 30 to reach the OLT 10.

The content of signal processing will be described along with the flow of signals.

First, with respect to an optical signal (downlink signal) from the OLT 10 to each of the ONUs 110, the transmission-side logic unit 11 executes a PON frame process for an electric signal. The transmission-side analog front-end unit 12 amplifies the electric signal after the PON frame process so as to obtain sufficient driving electric power for modulation at the optical transmitting unit 13. The optical transmitting unit 13 modulates sequential laser beams with the amplified signal, and outputs the modulated laser beams as optical signal. The optical signals are output based on the wavelengths, and the WDM 14 wavelength-multiplexes thirty-two waves to be output to the OLT-side optical fiber 40. The optical branching unit 30 branches the wavelength-multiplexed optical signal into thirty-two optical signals. The branched and wavelength-multiplexed optical signals reach the ONUs 110 through the ONU-side optical fibers 44.

It should be noted that the management signal transmitting unit 15 transmits a management optical signal with a wavelength of km. The management optical signal is wavelength-multiplexed with a downlink signal at the WDM 14, and is received by the optical branching unit 30. Specifically, the management optical signal is a control signal for the optical branching unit 30.

The wavelength-multiplexed optical signal input to each of the ONUs 110 is input to the optical receiving unit 112 while a specific wavelength is selected by the WDM 111. The optical receiving unit 112 converts the optical signal into the electric signal. The reception-side analog front-end unit 113 amplifies the electric signal converted by the optical receiving unit. The reception-side logic unit 114 performs the PON frame process for the amplified electric signal.

Next, with respect to an optical signal (uplink signal) from each of the ONUs to the OLT, the transmission-side logic unit 123 performs the PON frame process for the electric signal. The transmission-side analog front-end unit 122 amplifies the optical signal after the PON frame process so as to obtain sufficient driving electric power for modulation at the wavelength variable optical transmitting unit 121. The wavelength variable optical transmitting unit 121 modulates the sequential laser beams obtained by controlling oscillation wavelengths with an instruction from the OLT, and the modulated laser beams are output as optical signal. The optical signals pass through the WDM 111, and then are transmitted to the ONU-side optical fibers 44 through the optical connector 2. The optical branching unit 30 wavelength-multiplexes the optical signals received from the respective ONU-side optical fibers 44. The wavelength-multiplexed optical signal reaches the OLT 10 through the OLT-side optical fiber 40.

The WDM 14 performs wavelength demultiplexing for the wavelength-multiplexed optical signal input to the OLT 10 into each reception wavelength, and transmits demultiplexed optical signals to the respective optical receiving units 23-1 to 23-n. The optical receiving unit 23 converts the optical signal into the electric signal. The reception-side analog front-end unit 22 amplifies the converted electric signal. The reception-side logic unit 21 performs the PON frame process for the amplified electric signal.

Since highly-sensitive optical receiving units such as Avalanche PhotoDiodes (APDs) are used as the optical receiving units 23 of the OLT 10, input of an optical signal with an extraordinarily-high optical intensity from the ONU 110 by a hostile user possibly causes failure of the optical receiving units due to overload. Further, if the hostile user illegally accesses with a pseudo signal, the communication contents of the other users are possibly wiretapped.

With reference to FIG. 2, wavelength arrangement will be described. In FIG. 2, the horizontal axis represents a wavelength, and the vertical axis represents an optical intensity. In the WDM-PON system 200 where up to thirty-two ONUs are connected, a 1300 nm wavelength band and a 1500 nm wavelength band are used for signal transmission. Specifically, ITU-T G.983.1 recommends the use of 1260 nm to 1360 nm as the 1300 nm wavelength band and 1480 nm to 1580 nm as the 1500 nm wavelength band. In order to contain thirty-two wavelengths in each band, values from 1270 nm to 1332 nm with intervals of 2 nm can be used for the uplink signal, and values from 1482 nm to 1544 nm with intervals of 2 nm can be used for the downlink signal. As similar to the above, a wavelength of 1546 nm is assigned to the management optical signal λm.

With reference to FIG. 3, a configuration of the optical branching unit will be described. The optical branching unit 30 includes an OLT-side optical port 3, an OLT-side optical branching unit optical fiber 41, an optical coupler 51, an optical splitter 50, optical splitter-side optical branching unit optical fibers 42, optical blocking units 60, ONU-side optical branching unit optical fibers 43, ONU-side optical ports 4, an uplink signal WDM 52, optical receiving units 53, a controlling unit 54, driving units 55, a downlink signal WDM 70, and a downlink signal optical receiving unit 56.

The uplink optical signals input from the ONUs 110 to the ONU-side optical ports 4 are input to the optical splitter-side optical branching unit optical fibers 42 through the ONU-side optical branching unit optical fibers 43 and the optical blocking units 60. The uplink optical signals are wavelength-multiplexed with the other uplink optical signals by the optical splitter 50, and the optical power is branched into two by the optical coupler 51 to be output. Here, the branch ration of the optical power is 95:5. 95% of the optical power of the uplink optical signals is output to the OLT-side optical branching unit optical fiber 41 as a main signal, and then is input to the OLT 10 through the OLT-side optical port 3 and the OLT-side optical fiber 40. The remaining 5% of the uplink optical signals is input to the uplink signal WDM 52, and is demultiplexed into respective wavelengths. The optical signal after wavelength separation is converted into an electric signal by the optical receiving unit 53, and then is output to the controlling unit 54.

On the other hand, with respect to the downlink signal from the OLT 10, an optical signal with a wavelength λm is branched as a management optical signal by the downlink signal WDM 70. The WDM 70 inputs the management optical signal into the downlink signal optical receiving unit 56, and the optical signals with the other wavelengths are input to the coupler 51 as the downlink optical signals. The management optical signal contains information of wavelengths used-for transmitting and receiving signals between the respective ONUs 110 and the OLT 10. The downlink signal optical receiving unit 56 converts the management optical signal into a management electric signal, and transmits the management electric signal to the controlling unit 54. The controlling unit 54 obtains information of the uplink signal wavelengths assigned to the ONUs 110 from the management electric signal. The controlling unit 54 may obtain the information of the downlink signal wavelengths assigned to the ONUs 110 from the management electric signal.

When an extraordinarily-high output light is input from any one of the ONUs, the controlling unit 54 controls the driving unit 55-k to block the optical signal with a route (assumed as k) to which the uplink signal wavelength is assigned from the wavelength of the extraordinary optical signal at the optical blocking unit 60-k. When the extraordinary optical signal is still detected by the optical receiving unit 53 even after the blocking, the controlling unit stops the blocking at the optical blocking unit 60-k (transition into a transmission state), and sequentially blocks at the other optical blocking unit 60-1 to 60-n, so that the source ONU 110 of the extraordinary optical signal is specified. On the contrary, by sequentially bringing one of the optical blocking units 60-1 to 60-n into the transmission state, it is possible to determine that the route corresponds to a proper wavelength assigned from the OLT. As a result, even in the case where a hostile user illegally accesses by using a wavelength assigned to a different user, the optical blocking units 60 can block the corresponding optical signals.

Here, as the optical blocking units 60, optical shutters (light variable attenuators) or 1×2 optical switches are used. The state of each optical blocking unit 60 is in a blocking state or a transmission state. Accordingly, in the case where the extraordinary optical signal is removed by periodical transition to the transmission state of the optical blocking units, it is possible to automatically release the optical blocking state of the route. Specifically, if the optical shutters and the optical switches are used, the route can be returned to a normal state without intervention of a maintenance person to the optical blocking units. Further, the state transition of the optical blocking units may be controlled by using the management optical signal.

In the embodiment, by providing the optical blocking units 60, it is possible to avoid failure of the optical receiving units 23 of the OLT 10 caused by incidence of the optical signal with an extraordinarily-high optical intensity. In addition, in the case where it is determined as illegal access by analyzing the pseudo signal, the optical signal is blocked by the optical blocking units 60. Here, the optical blocking units 60 are optical components with features in which a light transmission rate is lowered by input of a light with a certain intensity or higher, or input of an illegal optical signal. Specifically, as the optical blocking units 60, optical fuses, optical shutters, or optical switches are used.

As a modified example of the above-described embodiment, it is conceivable that each optical blocking unit 60 is arranged right before each optical receiving unit 23 of FIG. 1. However, the optical signal is blocked after being wavelength-separated by the WDM 14 in this case. This problem will be described with reference to FIG. 4. In FIG. 4, the horizontal axis represents a wavelength, and the vertical axis represents an optical intensity. It should be noted that FIG. 4 is a schematic view for explanation as being apparent from that the optical signal intensity is constant for each wavelength and the optical blocking intensity is constant for each wavelength.

In FIG. 4, the extraordinary optical signal contains a wavelength band with a width interfering the communication wavelength bands of the other ONUs. The extraordinary optical signal contains a wavelength component λu4 with an optical intensity exceeding an optical blocking intensity threshold and a wavelength component λu5 with an optical intensity not exceeding the optical blocking intensity threshold. In this case, for the wavelength component λu4 with an optical intensity exceeding the optical blocking intensity threshold, input of the signal of the extraordinary optical signal is blocked by the optical blocking units 60. However, for the wavelength component λu5 with an optical intensity not exceeding the optical blocking intensity threshold, input of the signal of the extraordinary optical signal can not be blocked by the optical blocking units 60. As a result, the communications of the normal ONU using the wavelength component λu5 is still blocked. Therefore, in order to enhance the security and improve the quality of transmission, it is the most preferable that the optical blocking units 60 are arranged near the optical splitter-side optical branching unit optical fibers 42.

As described above, according to the embodiment, it is possible to realize a WDM-PON system with enhanced security and high reliability. As the optical transmitting units of the ONUs 110, the wavelength variable optical transmitting units are used in the above-described embodiment. However, the embodiment is not limited to this, but optical transmitting units for fixed wavelengths may be used. In this case, the management optical signal is not necessary.

What is claimed is:

1. An optical branching apparatus which is connected to a main fiber and a plurality of branch fibers, and in which an optical splitter is provided to branch a downlink optical signal from the main fiber into the branch fibers and a plurality of uplink optical signals from the branch fibers are wavelength-multiplexed, the apparatus comprising:
a coupler which is arranged between the main fiber and the optical splitter and branches the uplink wavelength-multiplexed optical signal into two;
an optical blocking unit which is arranged between the branch fibers and the optical splitter;
a first wavelength separating unit which is coupled to a first output of the coupler;
a plurality of optical receiving units which are connected to a plurality of outputs of the first wavelength separating unit;
a controlling unit which is connected to the plurality of optical receiving units and controls the optical blocking unit; and
an in-apparatus fiber which couples a second output of the coupler to the main fiber,
wherein when an extraordinary optical signal is detected by any one of the optical receiving units, the controlling unit controls the optical blocking unit for the corresponding uplink optical signal wavelength to be in a blocking state and blocks communications between the main fiber and the corresponding branch fiber.

2. The optical branching apparatus according to claim 1, wherein when the extraordinary optical signal is still detected even in a state where the optical blocking unit for the corresponding uplink optical signal wavelength is blocked, the controlling unit controls the optical blocking unit for the corresponding uplink optical signal wavelength to be in a transmission state, and sequentially controls the other optical blocking units to be in blocking states.

3. The optical branching apparatus according to claim 1,
wherein a second wavelength separating unit and a management signal receiving unit connected to the second wavelength separating unit are further provided in the in-apparatus fiber, and
the controlling unit holds a relation between the branch fibers and the optical signal wavelengths, the relation being received from the management signal receiving unit.

4. The optical branching apparatus according to claim 2,
wherein a second wavelength separating unit and a management signal receiving unit connected to the second wavelength separating unit are further provided in the in-apparatus fiber, and
the controlling unit holds a relation between the branch fibers and the optical signal wavelengths, the relation being received from the management signal receiving unit.

5. A passive optical network system, comprising:
an optical line termination;
an optical branching apparatus;
a plurality of optical network units:
a main fiber which couples the optical line termination to the optical branching apparatus; and
a plurality of branch fibers which couple the optical branching apparatus to the optical network units,
wherein the optical branching apparatus includes:
an optical splitter which branches a downlink optical signal from the main fiber into the branch fibers and wavelength-multiplexes a plurality of uplink optical signals from the branch fibers;
a coupler which is arranged between the main fiber and the optical splitter and branches an uplink wavelength-multiplexed optical signal into two;
an optical blocking unit which is arranged between the branch fibers and the optical splitter;
a first wavelength separating unit which is coupled to a first output of the coupler;
a plurality of optical receiving units which are connected to a plurality of outputs of the first wavelength separating unit;
a controlling unit which is connected to the optical receiving units to control the optical blocking unit; and
an in-apparatus fiber which couples a second output of the coupler to the main fiber, and when an extraordinary optical signal is detected by any one of the optical receiving units, the controlling unit controls the optical blocking unit for the corresponding uplink optical signal wavelength to be in a blocking state, and blocks communications between the main fiber and the corresponding branch fiber.
